(19) United States
(12) Patent Application Publication
(10) Pub. No.: US 2012/0232993 A1
(43) Pub. Date: Sep. 13, 2012

(54) REAL-TIME VIDEO IMAGE ANALYSIS FOR PROVIDING DEEPENING CUSTOMER VALUE

(75) Inventors: Matthew A. Calman, Charlotte, NC (US); Erik Stephen Ross, Charlotte, NC (US)

(73) Assignee: Bank of America Corporation, Charlotte, NC (US)

(21) Appl. No.: 13/342,068

(22) Filed: Jan. 1, 2012

Related U.S. Application Data
(60) Provisional application No. 61/450,213, filed on Mar. 8, 2011.
(60) Provisional application No. 61/508,971, filed on Jul. 18, 2011.

(51) Int. Cl. G06Q 30/02

(52) U.S. Cl. 705/14.58; 705/14.64

(57) ABSTRACT

System, method, and computer program product are provided for using real-time video analysis to provide deepening value offers for products or services to the user. Through the use of real-time vision object recognition objects, logos, artwork, products, locations, and other features that can be recognized in the real-time video stream can be matched to a directory associated with products a financial institution may be able to provide to the user at a discounted rate. Deepening value offers for product/services may be based on a financial institution's unique position with commercial partners. Commercial partners may be business, retailers, merchants, and/or manufacturers. In return for the deepening value offer, the financial institution may request the user deepen his/her relationship with the financial institution. This invention allows a user to receive an offer through his/her mobile device, in the form of a discount, at the point-of-sale for the same or similar product.

### CLAIM OF PRIORITY UNDER 35 U.S.C. §119

This Non-provisional patent application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/508,971 titled “Real-Time Video Image Analysis for Providing Deepening Customer Value” filed on Jul. 18, 2011, assigned to the assignee hereof and hereby expressly incorporated by reference herein.

### BACKGROUND

Individuals typically have a variety of choices when selecting a product to purchase. Subsequently, individuals also have several different methods in which to pay for that product. For example, an individual may wish to purchase a television. There are several choices of televisions, including brands, sizes, types, etc. In addition, once the individual has selected the television he/she may purchase the television with several different payment methods, including credit cards, retail cards, debit cards, cash, etc.

Many factors may play a role in an individual's selection of a particular television and subsequently the payment method used to complete the transaction. The individuals perception of the product, past use of the product, advertisement for the product, offers for discounts for the product, payment methods with the most rewards, etc. may all have a direct correlation with which product the individual purchases and what payment method the individual uses to complete the transaction.

Today, modern handheld mobile devices, such as smart phones or the like, have the capability to facilitate payment for a cup of coffee or provide a boarding pass for a flight. These advances combine multiple technologies through a handheld mobile device to provide a user with an array of capabilities. For example, many smart phones are equipped with significant processing power, sophisticated multi-tasking operating systems, and high-bandwidth Internet connection capabilities. Moreover, such mobile devices often have additional features that are becoming increasing more common and standardized features. Such features include, but are not limited to, location-determining devices, such as Global Positioning System (GPS) devices; sensor devices, such as accelerometers; and high-resolution video cameras.

As the capabilities of such mobile devices have increased, so too have the applications (i.e., software) that rely can be used with the mobile devices. One such example of innovative software is a category known as augmented reality (“AR”), or more generally referred to as mediated reality. One such example of an AR presentment application platform is Layar, available from Layar, Amsterdam, the Netherlands.

Even with these advances in technology, there are many individualized factors that determine an individual's purchase of one product over another product and the subsequent method of paying for the purchase of that product. Further, an individual may not know all the possible discounts, promotions, or savings opportunities when purchasing a product.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other devices) and methods for using real-time video analysis, such as AR or the like to provide offers to a user based on a financial institution's commercial relationship with a product's merchant, manufacturer, or retailer and possibly on the financial institution's relationship with the user.

The user may select any product in which he/she is wishing to purchase. Through the use of real-time vision object recognition, objects, logos, artwork, products, locations, and other features that can be recognized in the real-time video stream can be matched to a directory with data associated with a variety of products. In this way, the directory may determine the product that the user is capturing with the real-time video stream. In some embodiments, the data that is matched to the images in the real-time video stream is specific to financial institutions and financial institution commercial partners. In this regard, many of the embodiments herein disclosed leverage financial institution unique position, in providing a link between commercial partners of the financial institution and individual account holders or future account holders. In some embodiments, the data may be matched to a directory containing data about a user's favorite products. In other embodiments, the data may be matched to a directory containing data about a financial institution and its commercial partner's products. In yet other embodiments, the data may be matched to a directory containing product similar to the user's favorite products or commercial partner products.

Once the data supplied by the images in the real-time video stream specific to the user mobile device is matched to data within the directory, an indicator(s) is presented to the user's mobile device display. The indicators are associated with products captured in the real-time video stream display. For example, a user may provide an image in the real-time video stream of an aisle of a retail store. The data from the products within the aisle of the retail store is then matched to the directory.

One or more indicators are presented on the display of the mobile device in conjunction with the real-time video stream. Each of the indicators corresponds with an image of a product of which the individual might be interested. The indicator may take various forms, such as a display of a tag, a highlighted area, a hot-spot, and/or the like. In some embodiments, the indicator is a selectable indicator, such that the user may select (e.g., click-on, hover-over, touch the display, provide a voice command, etc.) the product or indicator to provide display of specific information related to the product in which the user is interested, including at least one indication of a discount offer for the product. In other embodiments, the indicator itself may provide the information or a portion of the information, without user selection.

The indicators provided to the user include offers that a product's merchant, retailer, or manufacture may provide for the product captured in the real-time video stream. In some embodiments the offers may be to products similar to the products captured in the real-time video display. Once the user has opted-in to receiving offers, a financial institution may provide the user with offers that may mirror or provide better savings to the user. This is due to the financial institutions unique position. A financial institution has several commercial partners. In this way, the commercial partners of the financial institution may be able to provide a select number of individuals greater discount opportunities for products. These greater discount opportunities or deepening value offers provide a user with special offers for the product, special offers for competing products or brands of products, or a special offer for a similar product from a competing retail store. The alternative products offered may be similar to the product selected by the user, but the competing product vendor or manufacturer may be a commercial partner of the financial institution providing the service.

Deepening value offers may be in the form of a discount, coupon, etc. that may expire within a predetermined amount of time or may be available to the user at any time he/she wishes to make a transaction. Deepening value offers are typically contingent on opening accounts or other lines of business with the financial institution.

The user of the AR presentment application may or may not be an account holder at the financial institution offering the greatest discount opportunities. However, the deepening value offer, if selected, may require the user to dynamically open a credit line or otherwise begin or deepen their relationship with the financial institution.

If the user selects the deepening value offer and begins or otherwise deepens their relationship with the financial institution by opening an account, accepts a line of credit (LOC), or otherwise enrolls in financial institution offers, the financial institution, through the possible use of the AR presentment application and the user's mobile device, may receive information and dynamically process the new account. Such that the new account or LOC may be used to purchase the product.

Embodiments of the invention relate to systems, methods, and computer program products for providing offers that are associated with products, comprising: building a directory of data relating to products; receiving product information from a mobile device; recognizing the product within the directory of data; matching the product information with the directory of data, through the use of a processing device; and presenting, via the mobile device of the user, an indicator associated with the product based on the recognition of the product within the directory, wherein upon selecting the indicator the user is provided an offer to purchase the product.

In some embodiments, building the directory of data relating to products includes products that are associated with commercial partners of a financial institution. The directory may also comprise manually inputted list data that indicates user product preferences. The directory may also comprise products that the commercial partners of the financial institution produce or sell. The product may be a good or service and the information associated with the product may comprise real-time imaging of a product.

In some embodiments, presenting an indicator associated with the product comprises displaying the indicator on a display of the mobile device. Presenting an indicator associated with the product further comprises superimposing the indicator over real-time video that is captured by the mobile device. Furthermore, the indicator may be selectable by the user. Upon being selected, the indicator provides a promotional offer for purchase of a product.

In some embodiments, the systems, methods, and computer program products for providing offers that are associated with products further comprise determining that the mobile device is capturing a real-time video stream comprising a depiction of the product prior to presenting the indicator associated with the product.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a high level process flow illustrating a real-time deepening value offer process, in accordance with one embodiment of the present invention;

FIG. 2 provides a deepening value offer determination system environment, in accordance with an embodiment of the invention;

FIG. 3 provides a block diagram illustrating a mobile device, in accordance with an embodiment of the invention;

FIG. 4 provides an a representation illustrating a mobile device real-time video stream display environment, in accordance with an embodiment of the invention;

FIG. 5 provides a process map for a providing a deepening value offer, in accordance with an embodiment of the invention;

FIG. 6 provides a process map for the analysis of selecting deepening value offers, in accordance with an embodiment of the invention; and

FIG. 7 provides a selection interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to users.

While embodiments discussed herein are generally described with respect to “real-time video streams” or “real-time video” it will be appreciated that the video stream may be captured and stored for later viewing and analysis. Indeed, in some embodiments, video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

Furthermore, embodiments discussed herein are generally described with respect to offers for “products.” Indeed, one of ordinary skill in the art will appreciate that products may include, but is not limited to goods, services, products, or other transactions requiring an exchange of funds.

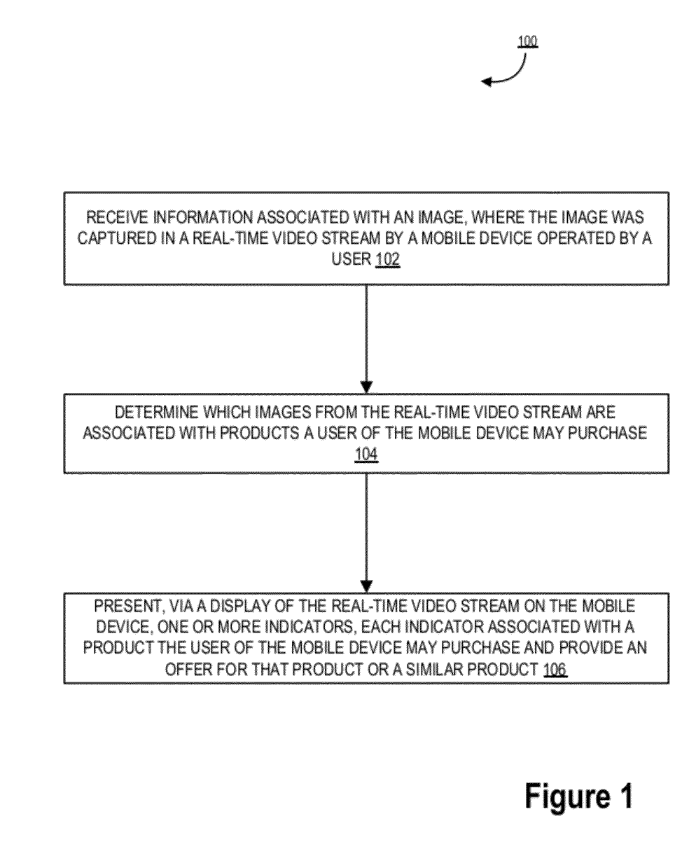

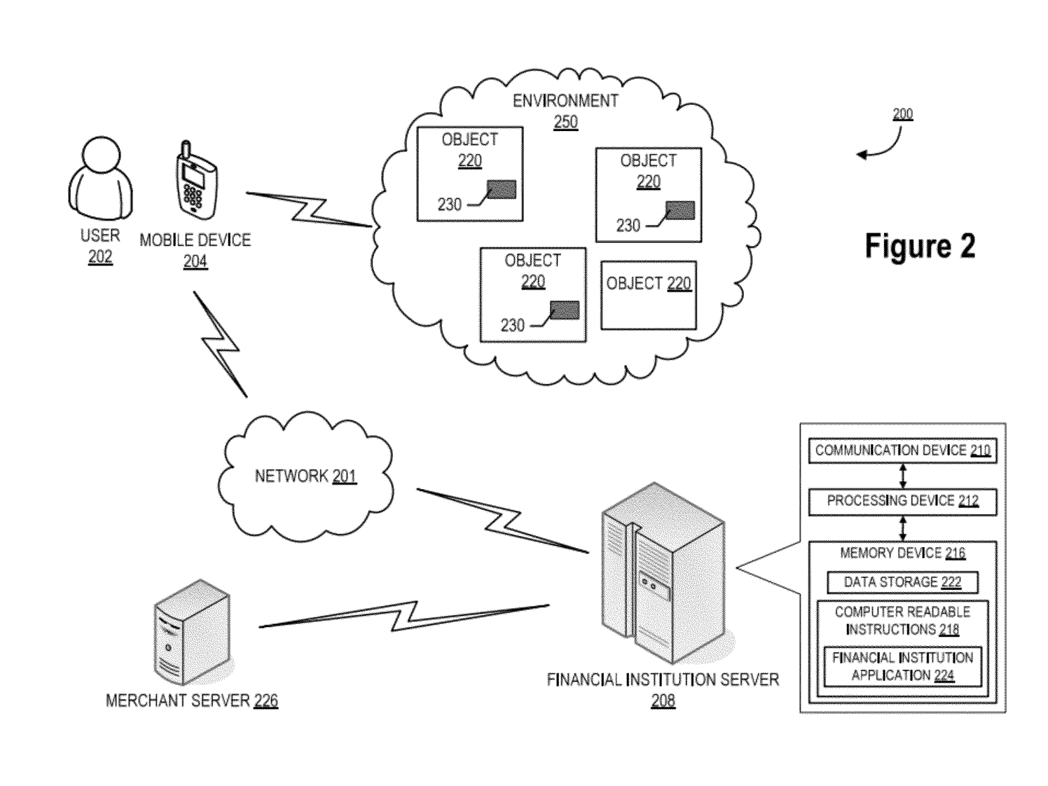

FIG. 1 illustrates a high level process flow of a real-time deepening value offer process 100, which will be discussed in further detail throughout this specification with respect to FIGS. 2 through 7. The first step in the deepening value offer process 100 is to receive information associated with an image, where the image was captured by a mobile device using real-time video stream, the mobile device operated by a user, as illustrated by block 102. A real-time video stream may include images of products, businesses, or the like. For example, a user may move about an aisle within a retail location while capturing a real-time video stream of the environment including the products on the shelves in the aisle. In another embodiment of the invention, a user may move about a city street or shopping mall while capturing a real-time video stream of the environment including the businesses located on the street or within the mall. In additional embodiments, the real-time video stream may be captured from a mobile device affixed to a moving vehicle, such as an automobile or the like, such that as the vehicle is driven, real-time video stream may be captured including images of the businesses that the vehicle passes.

Next, in block 104 a determination is made as to which images from the real-time video stream are associated with products that the user may wish to purchase. The determination is made by analyzing the real-time video stream for objects, logos, artwork, and/or other product-indicating features or business-indications features to determine what the products are within the video stream and to then provide matches (i.e., associations) for the products based on a directory of products. The directory of products may include a variety of products that the user of the mobile device may be interested in purchasing. The products may be from a variety of different merchants, retailers, or manufacturers. The products within the directory may include, but not limited to financial institution commercial partner products, popular products established independent of the user, or user inputted products.

Thereafter, at block 106 one or more indicators are presented on the display of the mobile device in conjunction with the real-time video stream. Each of the indicators is associated with an image in the real-time video stream and determined to be a product matched to a product in the directory. The indicator may take various forms, such as display of a tag, a highlighted area, a hot-spot, or the like. In specific embodiments, the indicator is a selectable indicator, such that a user may select (e.g., click-on, hover-over, touch the display, provide a voice command, and/or the like) the product, business logo, or indicator to provide display of specifics related to the product, business, or offers associated with the product. In some embodiments, the indicator itself may provide the information or a portion of the information to the user.

FIG. 2 provides a deepening value determination system environment 200, in accordance with one embodiment of the present invention. As illustrated in FIG. 2, the financial institution server 208 is operatively coupled, via a network 201 to the mobile device 204. In this way, the financial institution server 208 can send information to and receive information from the mobile device 204, to associate indicators within the real-time video stream to provide deepening value offers to the user 202. FIG. 2 illustrates only one example of an embodiment of a deepening value offer determination system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual. The user 202 may be at a retail store, near a business center, a city street, a shopping mail, and/or within real-time video range of any product and/or business for which the user 202 may wish to consider a transaction. The transaction may be made by the user 202 using the mobile device 204, such as a mobile wallet (i.e. smart phone, PDA, etc.) or other types of payment options, such as credit cards, checks, cash, debit cards, loans, lines of credit, virtual currency, etc. that allow the user 202 to make a transaction to purchase the good, service, etc.

As illustrated in FIG. 2, the financial institution server 208 generally comprises a communication device 210, a processing device 212, and a memory device 216. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 212 is operatively coupled to the communication device 210 and the memory device 216. The processing device 212 uses the communication device 210 to communicate with the network 201 and other devices on the network 201, such as, but not limited to the mobile device 204. As such, the communication device 210 generally comprises a modem, server, or other device for communicating with other devices on the network 201.

In some embodiments, the processing device 212 may also be capable of operating one or more applications, such as one or more applications functioning as an artificial intelligence (“AI”) engine. The processing device 212 may recognize objects that it has identified in prior uses by way of the AI engine. In this way, the processing device 212 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

As further illustrated in FIG. 2, the financial institution server 208 comprises computer-readable instructions 218 stored in the memory device 216, which in one embodiment includes the computer-readable instructions 218 of a financial institution application 224. In some embodiments, the memory device 216 includes data storage 222 for storing data related to targeted offers including but not limited to data created and/or used by the financial institution application 224 or a directory, including financial behavior, pre-selected favorites, recommendations, and/or special offers for consideration by the user 202.

In the embodiment illustrated in FIG. 2 and described throughout much of this specification, the financial institution application 224 may provide access to a directory storing information and/or offers for a variety of products including products of financial institution commercial partners, popular products, or user 202 inputted products. The directory may be used to determine matches between a product captured in a real-time video stream by a user 202 and products for which the system may be able to provide the user 202 a deepening value offer. In this way, the financial institution application 224 may recognize products captured by the user 202 in a real-time video stream as being an exact match to a product in the directory or similar to a product in the directory. The financial institution application 224, through an indicator, may then provide a deepening value offer to the user 202 for the product on the directory, which may be the exact product captured in the real-time video stream or a product similar thereto.

The directory may include products of commercial partners of the financial institution. In some embodiments, the deepening value offers provided to the user 202 may be from commercial partners of the financial institution. A financial institution may have several commercial partners. In this way, the commercial partners of the financial institution may be able to provide a select number of individuals greater discount opportunities for products. These greater discount opportunities or deepening value offers provide a user with special offers for a product associated with the commercial partner. The commercial partner may be a merchant, retailer, manufacturer or the like of products the user 202 may capture via real-time video stream or of products similar to the ones the user 202 captures. The similar products are similar to the product selected by the user 202, but the competing product vendor or manufacturer may be a commercial partner of the financial institution providing the service.

The directory may also include popular products. Popular products are either entered into or determined by the system and included in the directory. Popular products include electronics, toys, clothing, popular brand products, and/or the like. For example, a popular product may be a flat-panel television or the toy that every child wants for a holiday gift.

The financial institution application 224 further allows the user 202 to “opt-in” to manually input a watch list of products, via a mobile device 204 or other device with similar processing features such as a computer, tablet, hand held device, etc. The user 202 may input a watch list of products that he/she is planning on purchasing in the future. These inputted products may be added through an interface, social networking, etc. In this way, the user 202 may provide favorite products by several means, thus allowing for easy accessibility to update a user's 202 watch list.

The inputted products may be pre-programmed by the user 202 as AR preferences, so that the mobile device 204 may provide offers for the inputted products to the user 202. In one example, the processing device 310 of the mobile device 204 allows the user 202 to communicate, to products that he/she may wish to purchase in the future (i.e. a watch list), such as a list of items expensive “some day” items, such as a new television to the financial institution application 224. The data stored within the financial institution application 224 provides computer readable instructions 218 to the processing device 212 to allow for selection of these products during use in an environment 250. The financial institution application 224 stores the watch list for use by the user 202 when a real-time video stream indicator is available.

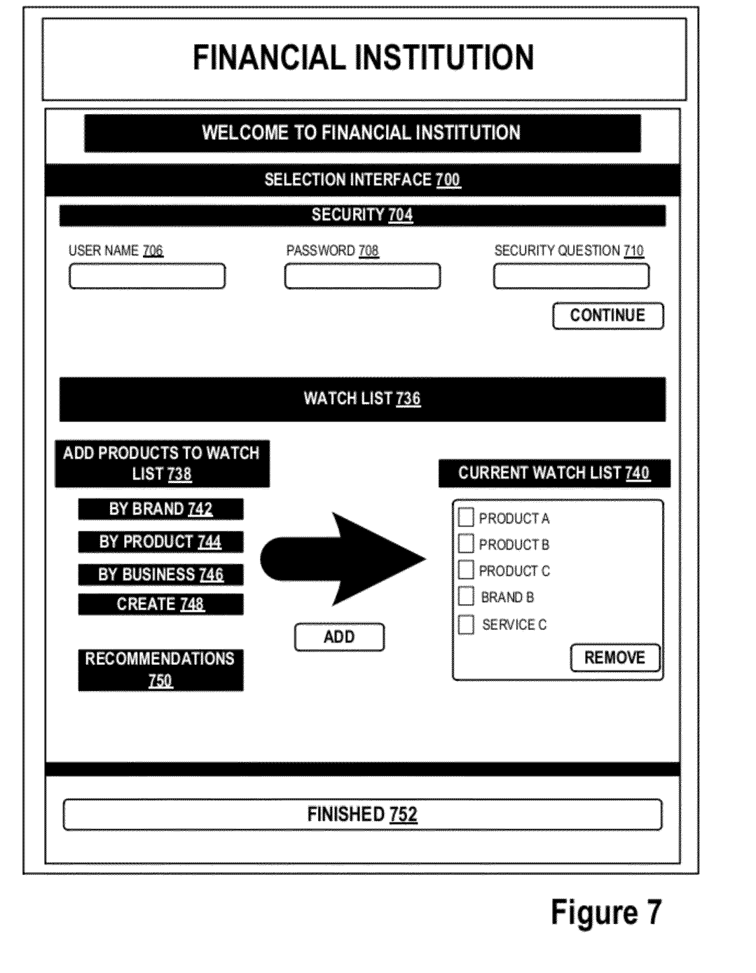

In some embodiments, as explained in further detail below a user 202 watch list may include products the user 202 would like to purchase. In one embodiment, watch list products may be provided to the directory by the user 202 through the use of an interface, such as that described in further detail below with respect to FIG. 7. The interface may be provided from a financial institution to the mobile device 204 of the user 202. The interface may also be provided from a financial institution to the user 202 through online banking means if the user 202 is a customer of the financial institution. Therefore the user 202 may access the interface in any means he/she would typically access online banking. In this way, the user 202 may provide watch list data at any time they have access to online banking. Watch list data may also be provided by the user 202 through the use of social networks. In this way, the individual may provide a list of products or business he/she is wishing to purchase on his/her social network page.

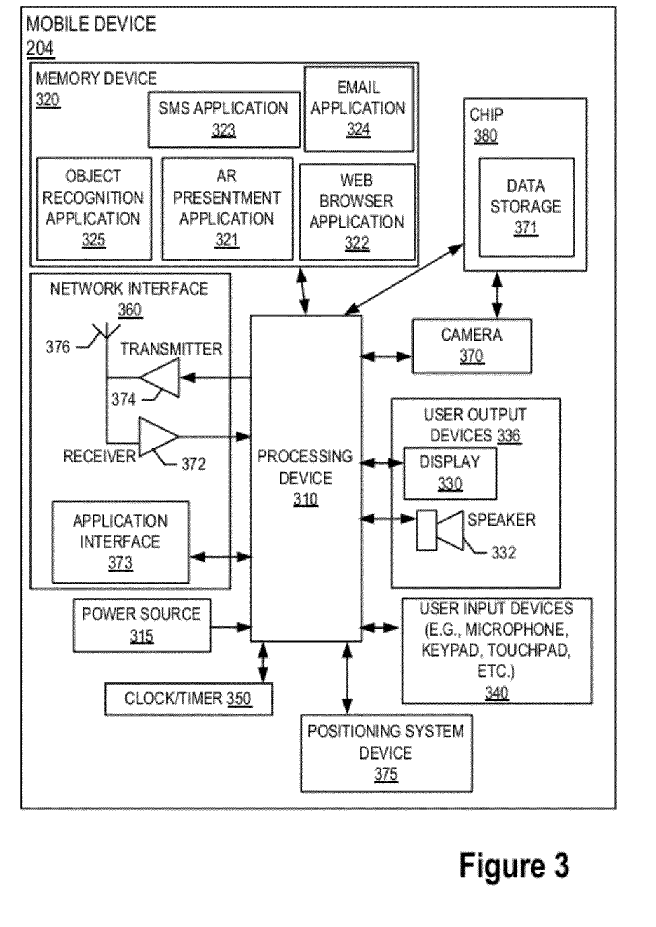

As further illustrated in FIG. 2, an environment 250 in which the user 202 utilizes a mobile device 204 to capture real-time video of an environment 250 is an augmented reality experience. As described in further detail below with respect to FIG. 3, the mobile device 204 may be any mobile communication device. The mobile device 204 has the capability of capturing real-time video of the surrounding environment 250. The real-time video capture may be by any means known in the art. In one particular embodiment, the mobile device 204 is a mobile telephone equipped with a camera capable of video capture.

The environment 250 contains a number of objects 220. Objects 220 include, but are not limited to goods or businesses the user 202 may wish to purchase or receive offers to purchase. For example, an object 220 may be a product, such as a television, vehicle, computer, etc. or an object 220 may be a business, such as a service, like a dry cleaner, pest control specialist, mechanics shop, etc. Some of such objects 220 may include a marker 230 identifiable to the mobile device 204. A marker 230 may be any type of marker that is a distinguishing feature that can be interpreted to identify specific objects 220. In some embodiments, the marker 230 may be interpreted by the mobile device 204. In other embodiments, the marker 230 may be interpreted by the financial institution server 208. In yet other embodiments, the marker 230 may be interpreted by both the mobile device 204 and the financial institution server 208. For instance, a marker may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the Marker 230 may be audio and the mobile device 204 may be capable of utilizing audio recognition to identify words or unique sounds broadcast. The marker 230 may be any size, shape, etc. Indeed, in some embodiments, the marker 230 may be very small relative to the object 220 such as the alpha-numeric characters that identify the name or model of an object 220, whereas, in other embodiments, the marker 230 is the entire object 220 such as the unique shape, size, structure, etc.

In some embodiments, the marker 230 is not actually a physical marker located on or being broadcast by the object 220. For instance, the marker 230 may be some type of identifiable feature that is an indication that the object 220 is nearby. In some embodiments, the marker 230 for an object 220 may actually be the marker 230 for a different object 220. For example, the mobile device 204 may recognize a particular building as being “Building A.” Data stored in the data storage 371 may indicate that “Building B” is located directly to the east and next to “Building A.” Thus, marker 230 for an object 220 that are not located on or being broadcast by the object 220 are generally based on fixed facts about the object 220 (e.g., “Building B” is next to “Building A”). However, it is not a requirement that such a marker 230 be such a fixed fact. The marker 230 may be anything that enables the mobile device 204 and/or the financial institution application 224 to interpret to a desired confidence level what the object is. For example, the mobile device 204, object recognition application 325 and/or AR presentation application 321 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 230 may also be, or include, social network data, such as data retrieved or communicated from the Internet, such as tweets, blog posts, social networking site posts, various types of messages and/or the like. In other embodiments, the marker 230 is provided in addition to social network data as mentioned above. For example, mobile device 204 may capture a video stream and/or one or more still shots of a large gathering of people. In this example, as above, one or more people dressed as characters in costumes may be present at a specified location. The mobile device 204, object recognition application 325, and/or the AR presentation application 321 may identify several social network indicators, such as posts, blogs, tweets, messages, and/or the like indicating the presence of one or more of the characters at the specified location. In this way, the mobile device 204 and associated applications may communicate information regarding the social media communications to the user and/or use the information regarding the social media communications in conjunction with other methods of object recognition. For example, the mobile device 204 object recognition application 325, and/or the AR presentation application 321 performing recognition of the characters at the specified location may confirm that the characters being identified are in fact the correct characters based on the retrieved social media communications. This example may also be applied objects outside of people.

In some embodiments, the mobile device and/or server accesses one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 220 with markers 230 only include a single marker 230, it will be appreciated that the object 220 may have any number of markers 230 with each equally capable of identifying the object 220. Similarly, multiple markers 230 may be identified by the mobile device 204 such that the combination of the markers 230 may be utilized to identify the object 220. For example, the facial recognition may identify a person as a famous athlete, and thereafter utilize the uniform the person is wearing to confirm that it is in fact the famous athlete.

In some embodiments, a marker 230 may be the location of the object 220. In such embodiments, the mobile device 204 may utilize GPS software to determine the location of the user 202. As noted above, a location-based marker 230 could be utilized in conjunction with other non-location-based markers 230 identifiable and recognized by the mobile device 204 to identify the object 220. However, in some embodiments, a location-based marker 230 may be the only marker 230. For instance, in such embodiments, the mobile device 204 may utilize GPS software to determine the location of the user 202 and a compass device or software to determine what direction the mobile device 204 is facing in order to identify the object 220. In still further embodiments, the mobile device 204 does not utilize any GPS data in the identification. In such embodiments, markers 230 utilized to identify the object 220 are not location-based.

In some embodiments the financial institution application 224 may recognized an Marker 230 and/or objects 220 within an environment 250. The marker 230 may be interpreted with respect to data in the memory device 216 and be recognized as a possible products and/or services that may be available to the user 202. In this way, the directory may be used to determine matches between a product captured in a real-time video stream by a user 202 and products for which the system may be able to provide the user 202 a deepening value offer. The financial institution application 224 may recognize products captured by the user in a real-time video stream as being an exact match to a product in the directory or similar to a product in the directory. If a match or similar product is found on the directory an indicator is presented associated with the product captured in the image via real-time video stream. In this way, the financial institution server 208 provides marker 230 interpretation and analysis with respect to the data on the financial institution server 208.

For example, the financial institution application 224 may identify an Marker 230 as being a specific television, the financial institution application 224 may then provide real-time data to the user 202 indicating any deepening value offer relating to that television or similar competitor televisions based on the recognition of the marker 230 to the user 202 via a mobile device 204.

The indicator associated with the product in the captured real-time video stream image may provide a deepening value offer to the user 202. The deepening value offer may be for the product in the captured image or a similar product. Deepening value offers may be in the form of a discount, coupon, promotion, rewards points, a low or zero percent interest rate for an extended period of time, etc. These offers may expire within a predetermined amount of time or may be available to the user 202 only at any time he/she wishes to make a transaction. Furthermore, offers may be related to the user's 202 prior financial institution relationships. For example, the offer may include accepting a LOC, but also lowering an interest rate on a current line of credit with the financial institution. Therefore, the system may provide for a dynamic extension of current credit, LOC, or lowering of current interest rates. The offer may also provide for extended warranties for the product. Deepening value offers are typically contingent on opening an account, brokerage account, or other lines of business with the financial institution.

The user 202 may or may not be an account holder at the financial institution offering the greatest discount opportunities. However, the deepening value offer, if selected, may require the user 202 to dynamically open a credit line or otherwise begin or deepen their relationship with the financial institution. For example, if the user 202 wishes to purchase a television using a deepening value offer, the user 202 may be required to open and pay for the television using a line of credit (LOC) from the financial institution.

The opening of a LOC, an account, a brokerage account, or other lines of business with the financial institution may be done dynamically through the use of the system. For example, the financial institution server 208 may gather information to process the new LOC for the purchase of the product by accessing and retrieving that information from the user's 202 mobile device 204, via the network 201. In this way, the user 202 may be able to quickly acquire a LOC to purchase a product with the deepening value offer.

If the user selects the deepening value offer and begins or otherwise deepens their relationship with the financial institution by opening an account, accepts a LOC, or otherwise enrolls in financial institution offers, the financial institution, through the use of the AR presentment application and the user's 202 mobile device 204, may receive information and dynamically process the new account. Such that the new account or LOC may be used to purchase the product. In some embodiments, the system may provide an offer to the user 202 that limits the cost of credit for the user 202 when making that purchase.

Furthermore, the indicators associated with the product may also provide the user 202 with an effect of the purchase, competing offers, or reviews of the product. In some embodiments, the system may provide the user 202 an indication as to the effects of the purchase. Such as how much the purchase will effect the user's 202 savings, how much monthly payments will be, cost of credit, etc. In yet other embodiments, the system may provide the user 202 with competing offers for the product. These offers may be from a financial institution, a retailer, a manufacturer, or the like. In still other embodiments, the system may provide the user 202 reviews for that product. The reviews may be in the form of comments, ratings, reviews, etc. for the product. The reviews may be from blogs, websites, social network sites, etc.

FIG. 2 also illustrates a merchant server 226. A merchant server 226 may be the server of a financial institution commercial partner. As such, the merchant server 226, may be associated with any commercial partner of the financial institution, such as merchants, manufacturers, retailers, or the like. The merchant server 226 is operatively coupled to the financial institution server 208. The merchant server 226 has systems with devices the same or similar to the devices described for the financial institution server 208 (i.e., communication device, processing device, and memory device). Therefore, the merchant server 226 communicates with the financial institution server 208 in the same or similar way as previously described with respect to each system. The merchant server 226 is a computing system that may communicate with the financial institution server 208 to provide the financial institution server 208 with up-to-date deepening value offers that the financial institution may provide to a user 202. In this regard, the financial institution server 208 may also communicate requests for deepening value offers to the merchant server 226 for acceptance.

FIG. 3 illustrates an embodiment of a mobile device 204 that may be configured to execute augmented reality functionality. A “mobile device” 204 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 204 may generally include a processing device 310 communicably coupled to such devices as a memory device 320, user output devices 336, user input devices 340, a network interface 360, a power source 315, a clock or other timer 350, a camera 370, a positioning system device 375, one or more chips 380, etc.

In some embodiments, the mobile device 204 and/or the server access one or more databases or datastores (not shown) to search for and/or retrieve information related to the object and/or marker. In some embodiments, the mobile device 204 and/or the server access one or more datastores local to the mobile device 204 and/or server and in other embodiments, the mobile device 204 and/or server access datastores remote to the mobile device and/or server. In some embodiments, the mobile device 204 and/or server access both a memory and/or datastore local to the mobile device 204 and/or server as well as a datastore remote from the mobile device 204 and/or server

The processing device 310 may include functionality to operate one or more software programs or applications, which may be stored in the memory device 320. For example, the processing device 310 may be capable of operating a connectivity program, such as a web browser application 322. The web browser application 322 may then allow the mobile device 204 to transmit and receive web content, such as, for example, location-based content and/or other web page content, according to a Wireless Application Protocol (WAP), Hypertext Transfer Protocol (HTTP), and/or the like.

The processing device 310 may also be capable of operating applications, such as an object recognition application 325 and/or an AR presentment application 321. The object recognition application 325 and/or the AR presentment application 321 may be downloaded from a server and stored in the memory device 320 of the mobile device 204. Alternatively, the object recognition application 325 and/or the AR presentment application 321 may be pre-installed and stored in a memory in the chip 380. In such an embodiment, the user 202 may not need to download the object recognition application 325 and/or the AR presentment application 321 from a server, but instead the server may be capable of running the object recognition application 325 and/or the AR presentment application 321. In some embodiments the object recognition application 325 and/or AR presentment application 321 may be ran on the mobile device 204 of the user 202 to provide object recognition and AR functionality. In other embodiments, other devices on the network 201 may provide object recognition and AR functionality.

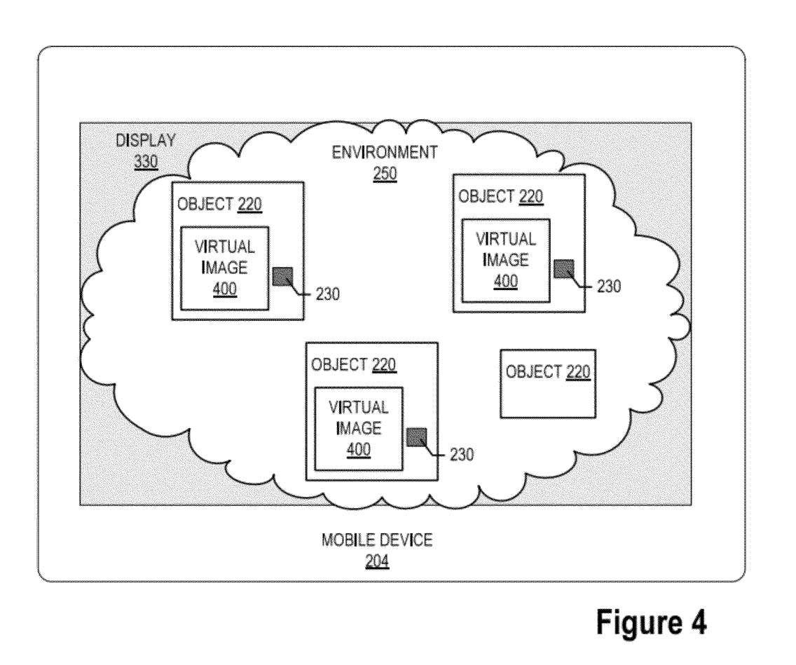

The object recognition application 325 provides the mobile device 204 with object recognition capabilities. In this way, objects 220 such as products and/or the like may be recognized by the object 220 itself and/or markers 230 associated with the objects 220. This is described in further detail below with respect to FIG. 4. In this way the object recognition application 325 may communicate with other devices on the network 201 to determine the object 220 within the real-time video stream.

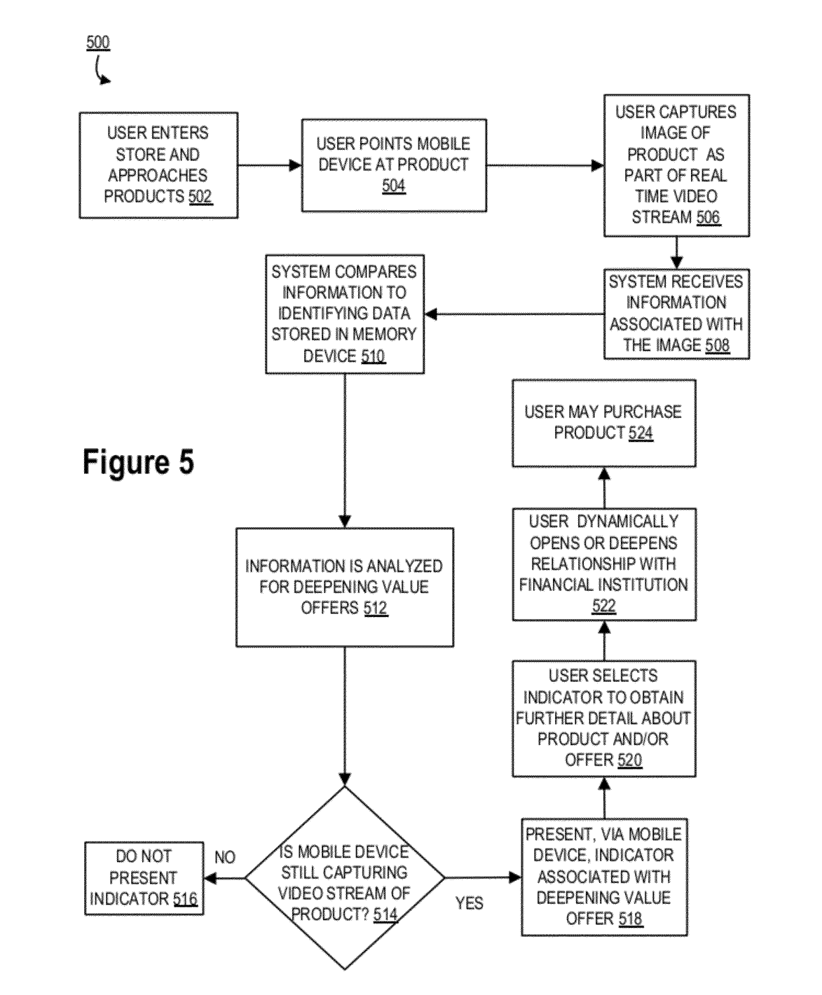

The AR presentment application 321 provides the mobile device 204 with AR capabilities. In this way, the AR presentment application 321 may provide superimposed indicators related to the object 220 in the real-time video stream, such that the user 202 may have access to the targeted offers by selecting an indicator superimposed on the real-time video stream. The AR presentment application 321 may communicate with the other devices on the network 201 to provide the user 202 with indications associated with targeted offers for objects 202 in the real-time video display. The presentation and selection of indicators provided to the user 202 via the AR presentment application 321 is described in further detail below with respect to FIG. 5.

The chip 380 may include the necessary circuitry to provide the AR functionality to the mobile device 204. Generally, the chip 380 will include data storage 371 which may include data associated with the objects within a real-time video stream that the object recognition application 325 identifies as having a certain marker(s) 230. The chip 380 and/or data storage 371 may be an integrated circuit, a microprocessor, a system-on-a-chip, a microcontroller, or the like. As discussed above, in one embodiment, the chip 380 may provide the object recognition and/or the AR functionality to the mobile device 204.

Of note, while FIG. 3 illustrates the chip 380 as a separate and distinct element within the mobile device 204, it will be apparent to those skilled in the art that the chip 380 functionality may be incorporated within other elements in the mobile device 204. For instance, the functionality of the chip 380 may be incorporated within the memory device 320 and/or the processing device 310. In a particular embodiment, the functionality of the chip 380 is incorporated in an element within the mobile device 204 that provides object recognition and/or AR capabilities to the mobile device 204. Still further, the chip 380 functionality may be included in a removable storage device such as an SD card or the like.

The processing device 310 may be configured to use the network interface 360 to communicate with one or more other devices on a network 201 such as, but not limited to the financial institution server 208. In this regard, the network interface 360 may include an antenna 376 operatively coupled to a transmitter 374 and a receiver 372 (together a “transceiver”). The processing device 310 may be configured to provide signals to and receive signals from the transmitter 374 and receiver 372, respectively. The signals may include signaling information in accordance with the air interface standard of the applicable cellular system of the wireless telephone network that may be part of the network 201. In this regard, the mobile device 204 may be configured to operate with one or more air interface standards, communication protocols, modulation types, and access types. By way of illustration, the mobile device 204 may be configured to operate in accordance with any of a number of first, second, third, and/or fourth-generation communication protocols and/or the like. For example, the mobile device 204 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 204 may also be configured to operate in accordance with non-cellular communication mechanisms, such as via a wireless local area network (WLAN) or other communication/data networks.

The network interface 360 may also include an application interface 373 in order to allow a user to execute some or all of the above-described processes with respect to the object recognition application 325, AR presentment application 321, and/or the chip 380. In some embodiments, the application interface 373 may further execute some or all of the above-described processes with respect to the financial institution application 224 by utilizing the object recognition application 325 and/or the AT presentment application 321. The application interface 373 may have access to the hardware, e.g., the transceiver, and software previously described with respect to the network interface 360. Furthermore, the application interface 373 may have the ability to connect to and communicate with an external data storage on a separate system within the network 201. In some embodiments, the external data is stored in the memory device 216 of the financial institution server 208.

As described above, the mobile device 204 may have a user interface that includes user output devices 336 and/or user input devices 340. The user output devices 336 may include a display 330 (e.g., a liquid crystal display (LCD) or the like) and a speaker 332 or other audio device, which are operatively coupled to the processing device 310. The user input devices 340, which may allow the mobile device 204 to receive data from a user 202, may include any of a number of devices allowing the mobile device 204 to receive data from a user 202, such as a keypad, keyboard, touch-screen, touchpad, microphone, mouse, joystick, other pointer device, button, soft key, and/or other input device(s).

The mobile device 204 may further include a power source 315. Generally, the power source 315 is a device that supplies electrical energy to an electrical load. In some embodiment, power source 315 may convert a form of energy such as solar energy, chemical energy, mechanical energy, etc. to electrical energy. Generally, the power source 315 in a mobile device 204 may be a battery, such as a lithium battery, a nickel-metal hydride battery, or the like, that is used for powering various circuits, e.g., the transceiver circuit, and other devices that are used to operate the mobile device 204. Alternatively, the power source 315 may be a power adapter that can connect a power supply from a power outlet to the mobile device 204. In such embodiments, a power adapter may be classified as a power source “in” the mobile device 204.

The mobile device 204 may also include a memory device 320 operatively coupled to the processing device 310. As used herein, memory may include any computer readable medium configured to store data, code, or other information. The memory device 320 may include volatile memory, such as volatile Random Access Memory (RAM) including a cache area for the temporary storage of data. The memory device 320 may also include non-volatile memory, which can be embedded and/or may be removable. The non-volatile memory may additionally or alternatively include an electrically erasable programmable read-only memory (EEPROM), flash memory or the like.

The memory device 320 may store any of a number of applications or programs which comprise computer-executable instructions/code executed by the processing device 310 to implement the functions of the mobile device 204 described herein. For example, the memory device 320 may include such applications as an object recognition application 325, AR presentment application 321, a web browser application 322, an SMS application 323, an email application 324, etc.

FIG. 4 further illustrates a mobile device 204 wherein the user 202 has executed an object recognition application 325, an AR presentment application 321, and a real-time video capture device (e.g., camera 370) is utilized to display the surrounding environment 250 on the display 330 of the mobile device 204. In some embodiments, the object recognition application 325 is configured to utilize markers 230 to identify objects 220, such as goods or businesses, and indicate to the user 202 identified objects 220 by displaying a virtual image 400 on the mobile device display 330. As illustrated in FIG. 4, if an object 220 does not have any markers 230 (or at least enough markers 230 to yield object identification), the object recognition application 325 will display the object 220 without an associated virtual image 400.

The object recognition application 325 may use any type of means in order to identify desired objects 220. For instance, the object recognition application 325 may utilize one or more pattern recognition algorithms to analyze objects in the environment 250 and compare with markers 230 in data storage 371 which may be contained within the mobile device 204 (such as within chip 380) or externally on a separate system accessible via the connected network 201, such as but not limited to the financial institution server 208. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 220 within the real-time video stream, the AR presentment application 321 is configured to superimpose a virtual image 400 on the mobile device display 330. The virtual image 400 is generally a tab or link displayed such that the user 202 may “select” the virtual image 400 and retrieve information related to the identified object. The information may include any desired information associated with the selected object and may range from basic information to greatly detailed information. In some embodiments, the virtual image 400 may provide the user 202 with an internet hyperlink to further information on the object 220. The information may include, for example, all types of media, such as text, images, clipart, video clips, movies, or any other type of information desired. In yet other embodiments, the virtual image 400 information related to the identified object may be visualized by the user 202 without “selecting” the virtual image 400.

In embodiments in which the virtual image 400 provides an interactive tab to the user 202, the user 202 may select the virtual image 400 by any conventional means for interaction with the mobile device 204. For instance, in some embodiments, the user 202 may utilize an input device 340 such as a keyboard to highlight and select the virtual image 400 in order to retrieve the information. In a particular embodiment, the mobile device display 330 includes a touch screen that the user may employ to select the virtual image 400 utilizing the user's finger, a stylus, or the like.

In some embodiments, the AR presentment application 321 provides virtual images 400 that are not interactive, but simply provide information to the user 202 by superimposing the virtual images 400 onto the display 330. For example, in some instances it may be beneficial for the object recognition application 325 to merely identify an object 220, and allow the AR presentment application 321 to just identify the object's name/title, give brief information about the object, etc., rather than provide extensive detail that requires interaction with the virtual image 400. The mobile device 204 is capable of being tailored to a user's desired preferences.

Furthermore, the virtual image 400 may be displayed at any size on the mobile device display 330. The virtual image 400 may be small enough that it is positioned on or next to the object 220 being identified such that the object 220 remains discernable behind the virtual image 400. Additionally, the virtual image 400 may be semi-transparent such that the object 220 remains discernable behind the virtual image. In other embodiments, the virtual image 400 may be large enough to completely cover the object 220 portrayed on the display 330. Indeed, in some embodiments, the virtual image 400 may cover a majority or the entirety of the mobile device display 330.

The user 202 may opt to execute the object recognition application 325 and/or the AR presentment application 321 at any desired moment and begin video capture and analysis. However, in some embodiments, the object recognition application 325 and/or the AR presentment application 321 includes an “always on” feature in which the mobile device 204 is continuously capturing video and analyzing the objects 220 within the video stream. In such embodiments, the object recognition application 325 may be configured to alert the user 202 that a particular object 220 has been identified. The user 202 may set any number of user preferences to tailor the AR experience to his/her needs. For instance, the user 202 may opt to only be alerted if a certain particular object 220 is identified. Additionally, it will be appreciated that the “always on” feature in which video is continuously captured may consume the mobile device power source 315 more quickly. Thus, in some embodiments, the “always on” feature may disengage if a determined event occurs such as low power source 315, low levels of light for an extended period of time (e.g., such as if the mobile device 204 is in a user's 202 pocket obstructing a clear view of the environment 250 from the mobile device 204), if the mobile device 204 remains stationary (thus receiving the same video stream) for an extended period of time, the user sets a certain time of day to disengage, etc. Conversely, if the “always on” feature is disengaged due to the occurrence of such an event, the user 202 may opt for the “always on” feature to re-engage after the duration of the disengaging event (e.g., power source 315 is re-charged, light levels are increased, etc.).

In some embodiments, the user 202 may identify objects 220 that the object recognition application 325 does not identify and add it to the data storage 371 with desired information in order to be identified and/or displayed in the future. For instance, the user 202 may select an unidentified object 220 and enter a name/title and/or any other desired information for the unidentified object 220. In such embodiments, the object recognition application 325 may detect/record certain markers 230 about the object so that the pattern recognition algorithm(s) (or other identification means) may detect the object 220 in the future. Furthermore, in cases where the object information is within the data storage 371, but the object recognition application 325 fails to identify the object 220 (e.g., one or more identifying characteristics or markers 230 of the object has changed since it was added to the data storage 371 or the marker 230 simply was not identified), the user 202 may select the object 220 and associate it with an object 220 already stored in the data storage 371. In such cases, the object recognition application 325 may be capable of updating the markers 230 for the object 220 in order to identify the object in future real-time video streams.

In addition, in some embodiments, the user 202 may opt to edit the information or add to the information provided by the virtual object 400 from the AR presentment application 321. For instance, the user 202 may opt to include user-specific information about a certain object 220 such that the information may be displayed upon a future identification of the object 220. Conversely, in some embodiments, the user 202 may opt to delete or hide an object 220 from being identified and a virtual object 400 associated therewith being displayed on the mobile device display 330.

Furthermore, in some instances, an object 220 may include one or more markers 230 identified by the object recognition application 325 that leads the object recognition application 325 to associate an object with more than one object in the data storage 371. In such instances, the user 202 may be presented with the multiple candidate identifications and may opt to choose the appropriate identification or input a different identification. The multiple candidates may be presented to the user 202 by any means. For instance, in one embodiment, the candidates are presented to the user 202 as a list wherein the “strongest” candidate is listed first based on reliability of the identification. Upon input by the user 202 identifying the object 220, the object recognition application 325 and/or the AR presentment application 321 may “learn” from the input and store additional markers 230 in order to avoid multiple identification candidates for the same object 220 in future identifications.

Additionally, the object recognition application 325 may utilize other bases for identification than identification algorithms. For instance, the object recognition application 325 may utilize the user's location, time of day, season, weather, speed of location changes (e.g., walking versus traveling), “busyness” (e.g., how many objects are in motion versus stationary in the video stream), as well any number of other conceivable factors in determining the identification of objects 220. Moreover, the user 202 may input preferences or other metrics for which the object recognition application 325 may utilize to narrow results of identified objects 220.

In some embodiments, the AR presentment application 321 may have the ability to gather and report user interactions with displayed virtual objects 400. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired.

In some embodiments, the information provided by the real-time video stream may be compared to data provided to the system through an API. In this way, the data may be stored in a separate application and be implemented by request from the mobile device 204 and/or server.

FIG. 5 illustrates a process map for a providing a deepening value offer using a real-time video stream 500. At block 502 the user 202 enters a business and approaches a product or is on a street and approaches products or businesses. A business may be, but is not limited to, a restaurant, retail store, vendor, shopping mall, warehouse, service provider, Internet store, or any other location where products or services are available. Additionally, a user 202 may see a business while driving down a street, walking, from a window, etc. In additional embodiments, a real-time video stream may be captured from a mobile device 204 affixed to a moving vehicle, such as an automobile or the like, such that as the vehicle moves, real-time video stream is captured including images of the businesses that the vehicle passes. In this way, a user 202 may either enter a business where products or services are located that the user 202 may wish to purchase. Once the user 202 enters the store or passes the business the user 202 may point his/her mobile device 204 at a product or the environment, as shown in block 504.

At block 506 the user 202 may capture images of products or businesses offering services, as part of a real-time video stream. In some embodiments, the user 202 may point his/her mobile device 204 at a product. In other embodiments, the user 202 may point his/her mobile device 204 at a business. Once the user has captured images, the system may receive the information associated with the image 508. The image may be a single frame of video (e.g., a screenshot), an entirety of a video, or any portion in between. Additionally, rather than video, the user 202 may opt to take a still picture of the environment. The image may further comprise of multiple single images compiled together. Once the financial institution application 224 or mobile device 204 receives the information associated with the image, a comparison of the information from the image to identifying data, or a directory, stored in the memory device is performed, as illustrated in block 510. The directory may determine the product in the image, from the information sent to the system. For example, if the user 202 is walking down a city street and he/she uses real-time video stream to identify a car dealership, the data from the image the user 202 took may provide data to the financial institution application 224 or the mobile device 204, though the object recognition application 325 and/or the AR presentment application 321, such that the vehicles available at that dealership may be known.

The directory includes information and/or offers for a variety of products including products of financial institution commercial partners, popular products, or user 202 inputted products. The products of the directory may be used to determine matches between a product captured in a real-time video stream by a user 202 and the products that the system may be able to provide the user 202 a deepening value offer for. In this way, the financial institution application 224 may recognize products captured by the user 202 in a real-time video stream as being an exact match to a product in the directory or similar to a product in the directory.

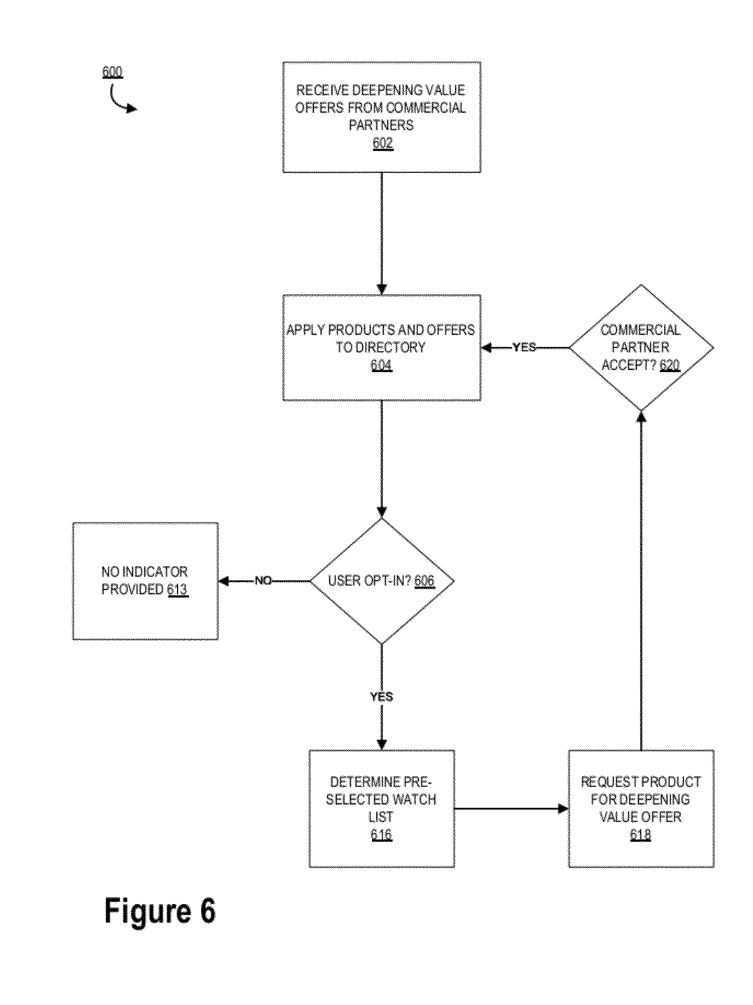

FIG. 6 illustrates the analysis for deepening value offers for a user's 202 possible purchase of a product 600. As illustrated by block 602, the process 600 begins by the system receiving information from commercial partners regarding possible products that the commercial partner may wish to include in the deepening value offer program. Then, as illustrated by block 604, the received products and information is applied to a directory. The directory may be used to determine matches between a product captured in a real-time video stream by a user 202 and products that the system may be able to provide the user 202 a deepening value offer for. In this way, the directory stores data associated with the products or business that the user 202 may be looking for. For example, a user 202 may be walking down the aisles of a retail store looking to purchase a computer. The computer the user 202 captures in the real-time video stream may be analyzed by the system to provide matches to the computer products within the directory. If a match is found (or a similar product is also found), the real-time video stream may provide the user 202 with an indicator indicating deepening value offers provided for the computer products.

As illustrated by block 606 in FIG. 6, the next step in the analysis 600 is to determine if the user 202 has provided an opt-in function for receiving offers through an object recognition application 325 and/or AR presentment application 321. If the opt-in function has been selected by a user 202, the financial institution may be able to provide the user 202 deepening value offers through the AR presentment application 321 the user 202 is utilizing. In some embodiments, the user 202 is a customer of the financial institution. In other embodiments, the user 202 is not a customer of the financial institution. In this way, the financial institution may provide deepening value offers to a user 202 irrespective of whether the user 202 is a current customer of the financial institution. If the user 202 does not choose to opt-in to using an object recognition application 325 and/or an AR presentment application 321 for receiving offers there no indicator is provided to the user 202 for a deepening value offer when an object 220 is seen through the real-time video stream as illustrated by block 613.

If the user 202 opts-in to receiving offers through an AR presentment application 321, the system may first determine a watch list of products of the user 202 in block 616. The user 202 may provide a watch list of products by using a selection interface, such as illustrated in FIG. 7, by social networking, by other selection methods which may include, but are not limited to sending a communication via email, text, voice message, video message/conference and/or the like.

FIG. 7 illustrates a selection interface 700 in accordance with some embodiments of the invention. If the user 202 has opted-in for receiving offers, the user 202 may provide watch list data. Watch list data may include products favored by the user 202, products the user 202 may want to purchase in the future, products that the user 202 is going to purchase in the future, etc. In one embodiment, watch list products may be provided to the directory by the user 202 through use of an interface, such as the selection interface 700. Watch list data may be provided to the system so that the system may attempt to provide the user 202 with products that are the same or similar to those on the watch list. The system may reach out to commercial partners of the financial institution to determine if the commercial partners are willing to offer their products on the deepening value offer program.

The selection interface 700 may be provided from a financial institution to the mobile device 204 of the user 202. Such that when the user 202 is using the object recognition application 325 and/or the AR presentment application 321 he/she may access the selection interface 700. The selection interface 700 may also be provided from a financial institution to the user 202 through online banking means. The user 202 may access the interface in any means he/she would typically access online banking FIG. 7 provides one embodiment of a selection interface 700 that allows a user 202 to opt-in to provide watch list products for the deepening value offer program. The system receives a request from a user 202 to set up a watch list. If the user 202 has not already enrolled, the system may prompt the user 202 to create a new account. As illustrated in the security section 704, the user 202 creates a user name 706 and password 708 for a new account or otherwise logs into the user's 202 watch list if the user 202 has previously set up a watch list. For example, illustrated in FIG. 7 is a selection interface 700 that allows a user 202 to create a log-in name and password to set up a watch list for deepening value offers. In some embodiments, the selection interface 700 requires entering information for security reasons 704. At this point, the user 202 may enter a user name 706, a password 708, and a reply to a security question 710. If the user name 706, password 708, and the reply to a security question 710 are satisfactory, the interface prompts the user 202 to the next step in the process. For example, if the user name 706 is being used by a current user 202, the new user 202 will be prompted to create a different user name 706. In some embodiments, the interface described herein may be accessed through the user's 202 online banking application. In some embodiments, the interface described herein may be accessed through the AR presentment application 321 using a mobile device 204.

The user 202 may continue to set up his/her watch list. The selection interface 700 may provide a watch list section 736 for adding products to the watch list and for viewing products currently on the watch list. In the add products to watch list section 738, the user 202 may select the product in which he/she may wish to add to the deepening value offer program. The user 202 may add products to the watch list by brand 742 which will allow a user 202 to the brand of a business or product to his/her watch list. For example, the user 202 may be brand loyal when he/she is purchasing vehicles. Therefore he/she may add the brand of vehicles to his/her watch list, in this way, when a deepening value offer arises for that brand of vehicle, the user 202 may know about it and be able to act on the offer. The user 202 may add favorites by product 744. For example, a user 202 may select a watch list product by inputting a product type, such as a computer. The user 202 may add favorites by business 746. For example, a user 202 may be looking for a specific type of store, such as a home improvement store. He/She may add home improvement stores to his/her watch list, such that the system may indicate any deepening value offers that may be provided from a home improvement store. The user 202 may add products to his/her watch list by creating a new search under the create section 748. In this way, the user 202 may provide new or more refined search criteria to add watch list products to the watch list. The user 202 may also select from a list of recommendations 750. In some embodiments, the recommendations may be a list of items recommended from consumers. In some embodiments, recommendations may be an analysis of products that the user 202 typically purchases and a list of those products. In yet other embodiments, recommendations may be a list of products that are popular among the deepening value offer program. Once the user 202 has selected the product or business by brand 742, by product 744, by business 746, by creating a search 748, or by a recommendation 750 the user 202 may add the product or business to the list of favorites 740, by selecting the add button.

Once the user 202 has completed adding to his/her watch list he/she may view his/her current watch list in section 740. The watch list may be a compilation of all the products that the user 202 has added. The watch list may have been added during a previous log-in session or during the current log-in session. If the user 202 wishes, he/she may remove a product from his/her current watch list 740 if it is no longer a product that the user 202 may wish to purchase. Once the user 202 has completed adding or removing products from his/her watch list, to save data added or removed the user 202 may select the finish button 752.

Using the selection interface 700 or other means the user 202 may provide a pre-selected watch list of products that the user 202 may purchase in the future. The system may review the watch list provided by the user 202 and in block 618 send a request to the commercial partners of the financial institution to offer products (or similar products thereto) on the user's 202 watch list to the user 202 via a deepening value offer. The system may present the request by indicating to the commercial partner that there are several individuals that are likely to purchase a product if it is offered through the deepening value offer program in block 618. For example, the system may recognize one hundred individual users that have a product of the commercial partner on their respective watch list. In this way, it is likely that several of the hundred users will purchase the product if it is offered a greater than standard discount, such as a deepening value discount. In this way, the commercial partner may receive several purchase requests through the single request from the system. If the commercial partner accepts the request from the system in decision block 620, the product is included in the directory at block 604.

Referring back to FIG. 5, once the directory is established at block 510 information received from image captured as a part of the real-time video stream is analyzed for deepening value offers with respect to the information established on the directory. The deepening value offers are discounts, offers, or promotions the financial institution may provide the user 202 based on the financial institution's unique position with respect to commercial partners, such as merchants, retailers, and/or manufacturers.

Analyzing the information for deepening offer selection determines products or businesses captured in the real-time video stream by a user 202 to the information regarding products on the directory. In this way, the financial institution application 224 may compare the directory to the information received from the real-time video stream to determine of any of the products or businesses in the environment are products offered by commercial partners for the deepening value offer, or watch list products of the user 202. The determination of matches between the directory and the information provided by the real-time video stream may, in some embodiments, be determined by the mobile device 204. In other embodiments, the determination of matches between the directory and the information provided by the real-time video stream may provided by the financial institution application 224.

With the matches between the directory and the information from the real-time video stream determined in block 512, a determination is made as to whether the mobile device is still capturing video stream of a product and/or business in decision block 514. If no video stream is being captured then no indicator is presented in block 516. If a video stream is still being captured, then in block 518 indicators are presented with respect products in the real-time video stream. The indicators are associated with a product and/or business that the user 202 may visualize in an environment 250. The user 202 is provided indicators via his/her mobile device 204. The indicators may provide deepening value offers based on products and business found in the directory. In some embodiments, the deepening value offer may be provided in real-time in the environment 250 by the indicator 230. In some embodiments, the deepening value offer may be provided to the user 202 after the user 202 selects the indicator 230. In some embodiments, the user 202 may be provided a deepening value offer prior to selecting an indication. In some embodiments, as illustrated in block 520, a user 202 may receive a deepening value offer after the user 202 selects the indicator.

If the user 202 selects the indicator in block 520, the user 202 is provided further detail about the product and deepening value offers available for that product or business (or a similar product). The selected indicator may provide more detailed information with respect to characteristics of the product. For example, the detailed information a television may include its suggested retail price, size, type, brand, prices of similar brands, reviews of the television, etc.

The deepening value offer indicators may include, but are not limited to detailed information about the product, such as dimensions, type, brand, suggested retail price, etc. and offers provided by financial institution commercial partners.

The offers may be promotions, discounts, coupons, etc. for the product or for similar products the commercial partner may manufacture or retail. The offers may expire within a predetermined amount of time or may be available to the user at any time he/she wishes to make a transaction. The deepening value offers may also be contingent on opening accounts or other lines of business with the financial institution. Starting or deepening a relationship with the financial institution by opening accounts may be directly associated with the transaction or be completely independent of the transaction. For example, a user 202 may be in at a vehicle dealership. The user 202 may be shopping for a truck. When the user 202 uses the real-time video stream an indicator may be provided for a brand A of truck. When he/she selects the indicator for brand A truck, detailed information about brand A truck may be provides, such as the options, suggested retail price, etc. A deepening value offer may also be provided to the user 202 when he/she selects the indicator. However, brand A may not be a commercial partner of the financial institution; therefore the AR presentment application may not be able to provide a deepening value offer to the user 202 for a brand A truck. However, brand B may be a commercial partner. Brand B may have a comparable truck, the brand B truck. Therefore, the system, through use of the indicator, may provide the user 202 a deepening value offer for brand B truck. The offer may provide for such a discount (and thus a savings to the user 202), that the user 202 may wish to accept the offer and purchase brand B truck using the deepening value offer.

At block 522 the user 202 may have to dynamically open or otherwise deepen his/her relationship with the financial institution if the user 202 wishes to utilize the deepening value offer. In some embodiments, the user 202 may already have a relationship with the financial institution. This relationship may comprise of any time of account, mortgage, investment, loan, etc. that the user 202 may have or previously had at the financial institution. In other embodiments, the user 202 may not have a relationship with the financial institution. The system may require the user 202 open an account, LOC, or other relationship with the financial institution in order to receive the benefits of the deepening value offer.

In some embodiments, the relationship opened or otherwise deepened may be required for payment for the product. For example, the system may require the user 202 to dynamically open a LOC with the financial institution to purchase the brand B truck with the deepening value offer. The LOC the user 202 may have to open to receive the deepening value offer may also have to be used as payment for the purchase of the brand B truck. In this way, the financial institution server 208 may receive all the required information from the user 202 through the user's 202 mobile device 204 to open a new LOC. The required information may be sent upon selection of the indicator, such that the user 202 may have qualified for the LOC prior to the user 202 purchasing the product. Therefore, the LOC funds will be dynamically available for the user 202 to use as tender for the purchase of the product.

In other embodiments, the account or LOC the user 202 may have to open to receive the deepening value offer may not have to be used to purchase the product. For example, the system may require the user 202 to enroll in a credit card offered by the financial institution, in order to receive the deepening value offer. Although, the user 202 may have already received qualification and approval for the credit card dynamically by the mobile device 204 and the financial institution server 208 communicating to dynamically authorize the user 202 for enrollment in the credit card, the user 202 may not have to use the credit card for purchase of the product. However, purchase of the product using the deepening value offer automatically enrolls the user 202 in the credit card dynamically, upon selection of purchasing the product, in block 524.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as user financial behavior history, user purchase power/transaction history and the like. In this regard, many of the embodiments herein disclosed leverage financial institution data, which is uniquely specific to financial institution, in providing information to mobile devices users in connection with real-time video stream analysis.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real Estate |
| | | Listings |
| 61/478,402 | Apr. 22, 2011 | Real-Time Video Image Analysis for an |
| | | Appropriate Payment Account |
| 61/478,405 | Apr. 22, 2011 | Presenting Investment-Related Information |
| | | on a Mobile Communication Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a |
| | | VideoStream Captured by a Mobile |
| | | Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With an |
| | | Identified Representation of an Object |
| 61/478,415 | Apr. 22, 2011 | Providing Location Identification of |
| | | Associated Individuals Based on |
| | | Identifying the Individuals in Conjunction |
| | | With a Live Video Stream |
| 61/478,419 | Apr. 22, 2011 | Vehicle Recognition |
| 61/478,417 | Apr. 22, 2011 | Collective Network of Augmented Reality |
| | | Users |
| 61/508,985 | Jul. 18, 2011 | Providing Information Regarding Medical |
| | | Conditions |
| 61/508,946 | Jul. 18, 2011 | Dynamically Identifying Individuals From |
| | | a Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a |
| | | Mobile Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,764 | Jul. 18, 2011 | Conducting Financial Transactions Based |
| | | on Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

What is claimed is:

1. A method for providing offers that are associated with products, comprising:
building a directory of data relating to products;
identifying, via a computer device processor, one or more products proximate in location to a mobile device;
recognizing the products identified that are proximate in location to the mobile device;
matching the products in the directory with products identified that are proximate in location to the mobile device, wherein the matching is based at least in part on the directory of data and the products recognized that are proximate in location to the mobile device; and
presenting, via the mobile device, an indicator associated with the product based at least in part on the recognition of the product within the directory, wherein upon selecting the indicator the user is provided an offer to purchase the product.

2. The method of claim 1 further comprising building the directory of data relating to products, wherein the products are associated with commercial partners of a financial institution

3. The method of claim 1, wherein the directory comprises manually inputted list data, wherein the list data indicates user products preferences.

4. The method of claim 1, wherein the directory comprises products that the commercial partners of the financial institution produce or sell.

5. The method of claim 1, wherein identifying one or more products proximate in location to the mobile device further comprises real-time imaging of the one or more products.

6. The method of claim 1, wherein the product is a service provided by a business.

7. The method of claim 1, wherein presenting an indicator associated with the product comprises displaying the indicator on a display of the mobile device.

8. The method of claim 1, wherein presenting an indicator associated with the product comprises superimposing the indicator over real-time video that is captured by the mobile device.

9. The method of claim 1, wherein the indicator is selectable by the user.

10. The method of claim 1, wherein the indicator, upon being selected, provides a promotional offer for purchase of a product.

11. The method of claim 1, further comprising determining that the mobile device is capturing a real-time video stream comprising a depiction of the product prior to presenting the indicator associated with the product.

12. The method of claim 1, wherein identifying one or more products proximate in location to a mobile device further comprises capturing a tag on or proximate to the one or more product and reading, via a computer device processor, the tag to identify the product.

13. A system for providing offers that are associated with products, comprising:
a memory device;
a communication device;
a processing device operatively coupled to the memory device and the communication device, wherein the processing device is configured to execute computer-readable program code to:
build a directory of data relating to products;
identify one or more products proximate in location to a mobile device;
recognize the products identified that are proximate in location to the mobile device;
match the products in the directory with products identified that are proximate in location to the mobile device, wherein the matching is based at least in part on the directory of data and the products recognized that are proximate in location to the mobile device; and
presenting, via the mobile device, an indicator associated with the product based at least in part on the recognition of the product within the directory, wherein upon selecting the indicator the user is provided an offer to purchase the product.

14. The system of claim 13 further comprising building the directory of data relating to products, wherein the products are associated with commercial partners of a financial institution

15. The system of claim 13, wherein the directory comprises manually inputted list data, wherein the list data indicates user products preferences.

16. The system of claim 13, wherein the directory comprises products that the commercial partners of the financial institution produce or sell.

17. The system of claim 13, wherein identifying one or more products proximate in location to the mobile device further comprises real-time imaging of the one or more products.

18. The system of claim 13, wherein the product is a service provided by a business.

19. The system of claim 13, wherein presenting an indicator associated with the product comprises displaying the indicator on a display of the mobile device.

20. The system of claim 13, wherein presenting an indicator associated with the product comprises superimposing the indicator over real-time video that is captured by the mobile device.

21. The system of claim 13, wherein the indicator is selectable by the user.

22. The system of claim 13, wherein the indicator, upon being selected, provides a promotional offer for purchase of a product.

23. The system of claim 13, further comprising determining that the mobile device is capturing a real-time video stream comprising a depiction of the product prior to presenting the indicator associated with the product.

24. The system of claim 13, wherein identifying one or more products proximate in location to a mobile device further comprises capturing a tag on or proximate to the one or more product and reading, via a computer device processor, the tag to identify the product.

25. A computer program product for providing offers that are associated with products, the computer program product comprising at least one non-transitory computer-readable medium having computer-readable program code portions embodied therein, the computer-readable program code portions comprising:
an executable portion configured for building a directory of data relating to products;
an executable portion configured for identifying one or more products proximate in location to a mobile device;
an executable portion configured for recognizing the products identified that are proximate in location to the mobile device;
an executable portion configured for matching the products in the directory with products identified that are proximate in location to the mobile device, wherein the matching is based at least in part on the directory of data and the products recognized that are proximate in location to the mobile device; and
an executable portion configured for presenting, via the mobile device, an indicator associated with the product based at least in part on the recognition of the product within the directory, wherein upon selecting the indicator the user is provided an offer to purchase the product.

26. The computer program product of claim 25 further comprising building the directory of data relating to products, wherein the products are associated with commercial partners of a financial institution

27. The computer program product of claim 25, wherein the directory comprises manually inputted list data, wherein the list data indicates user products preferences.

28. The computer program product of claim 25, wherein the directory comprises products that the commercial partners of the financial institution produce or sell.

29. The computer program product of claim 25, wherein identifying one or more products proximate in location to the mobile device further comprises real-time imaging of the one or more products.

30. The computer program product of claim 25, wherein the product is a service provided by a business.

31. The computer program product of claim 25, wherein presenting an indicator associated with the product comprises displaying the indicator on a display of the mobile device.

32. The computer program product of claim 25, wherein presenting an indicator associated with the product comprises superimposing the indicator over real-time video that is captured by the mobile device.

33. The computer program product of claim 25, wherein the indicator is selectable by the user.

34. The computer program product of claim 25, wherein the indicator, upon being selected, provides a promotional offer for purchase of a product.

35. The computer program product of claim 25, further comprising determining that the mobile device is capturing a real-time video stream comprising a depiction of the product prior to presenting the indicator associated with the product.

36. The computer program product of claim 25 wherein identifying one or more products proximate in location to a mobile device further comprises capturing a tag on or proximate to the one or more product and reading, via a computer device processor, the tag to identify the product.
